(19) United States
(12) Patent Application Publication
(10) Pub. No.: US 2008/0222273 A1
(43) Pub. Date: Sep. 11, 2008

(54) Adaptive rendering of web pages on mobile devices using imaging technology

(75) Inventors: Thyagarajan Lakshmanan, Redmond, WA (US); Ting-yi Yang, Redmond, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/714,939

(22) Filed: Mar. 7, 2007

(51) Int. Cl. G06F 15/16

(52) U.S. Cl. 709/219

(57) ABSTRACT

Described is browsing websites with a small form-factor (e.g., mobile) device that is similar to a desktop browsing experience, without requiring websites to redesign pages for such devices. A server responds to client requests for page content by providing server-rendered image data to the requesting client, along with properties of elements of the page represented in the image data. The client displays a representation of the page based on the image data, and uses the property data to emulate interaction with the page rather than the image that is actually being displayed. The server may provide tiles corresponding to zoomed-in portions of the page, or the client device may generate tiles from the image data. Using the tiles, element properties and a moveable/resize-able zoom rectangle provided to the user, the client device can zoom into the page to facilitate interaction with the elements in that area.

### BACKGROUND

On a mobile communications device equipped with Internet access, such as a Smartphone, the user experience when browsing most websites is relatively poor compared to a desktop browsing experience. This is because most current web sites are not designed for browsing on small form-factor devices. As a result, it is very difficult to browse and navigate websites using such devices.

One attempted solution to providing an improved mobile browsing experience is to redesign websites to be mobile device-friendly. However, such a redesign generally means drastically downsizing the richness of the web page, and further, any such redesign requires additional development work.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a server that communicates with one or more (e.g., mobile) client devices to respond to requests for page content with image data and properties of elements of the page represented in the image data. The client receives the image data corresponding to a server-rendered image of the page, and displays a representation of the page based on the image data. The client uses the property data to convert user input actions relative to the displayed representation into interactive browsing actions relative to elements of the page that are visible in the displayed representation. The client thus emulates interaction with an actual page rather than the image that is actually displayed.

In one alternative, the server provides tiles corresponding to zoomed-in portions of the page to the client, e.g., in a background operation and/or as requested on demand by the client. In another alternative, the client device generates the tiles from the page image data. The client device provides a zoom area, whereby the user can zoom into the displayed representation of the page, by using the tiles to construct and display enlarged image of the page that corresponds to the zoomed-in area. The zoom area may be resized and/or moved.

In this manner, browsing websites with a small form-factor device is much more similar to a desktop browsing experience. Further, a website need not redesign its pages for such devices.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing an example mobile device that is configured for receiving from a server a static image and meta file that corresponds to a webpage.

FIG. 2 is a block diagram representing an example mobile device that is configured for receiving tiles, each tile comprising a static image that corresponds to part of a webpage.

FIG. 3 is a block diagram representing example server components that provide thumbnail and tile images of web pages from contents provider to a mobile device.

FIG. 4 is a representation of a thumbnail image of a webpage rendered on a mobile device having a zoom selection mechanism.

FIG. 5 is a representation of a subset of tiles of a webpage including portions of selected tiles zoomed in for larger viewing on a mobile device.

FIG. 6 is a flow diagram representing server logic for providing image data and meta file of page properties to a mobile device.

FIG. 7 is a flow diagram representing client logic for displaying a thumbnail image and for selectively zooming into tiles of the webpage.

FIG. 8 is a flow diagram representing client logic for interacting with a zoomed in webpage.

### DETAILED DESCRIPTION

Various aspects of the technology described herein are generally directed towards a web browsing solution that converts a web page to an image for rendering on a mobile device, while at the same time allowing the user to interact with the web page. For example, data corresponding to the hyperlinks and form inputs on the web pages are preserved, allowing the user to navigate to other pages and enter form data, even though the user is actually interacting by operating above a displayed image of the page. As will be readily apparent, the technology described herein provides a browsing experience on mobile devices that is essentially the same as a desktop computer browsing experience, including zoom-in, zoom-out and panning support. Moreover, there is no need to redesign web sites for mobile devices.

While one example implementation described herein includes example server and client software in the form of various components that work together to render a web page as an image while retaining the web page's interactive nature, it is understood that these are only example components in an example mobile browsing environment. Alternative environments are feasible, and indeed, the technology described herein may be implemented on any type of computing device, including a personal computer.

As such, the present invention is not limited to any particular embodiments, aspects, concepts, protocols, structures, mechanisms, algorithms, functionalities or examples described herein. Rather, any of the embodiments, aspects, concepts, protocols, structures, mechanisms, algorithms, functionalities or examples described herein are non-limiting, and the present invention may be used various ways that provide benefits and advantages in computing and user interface navigation in general.

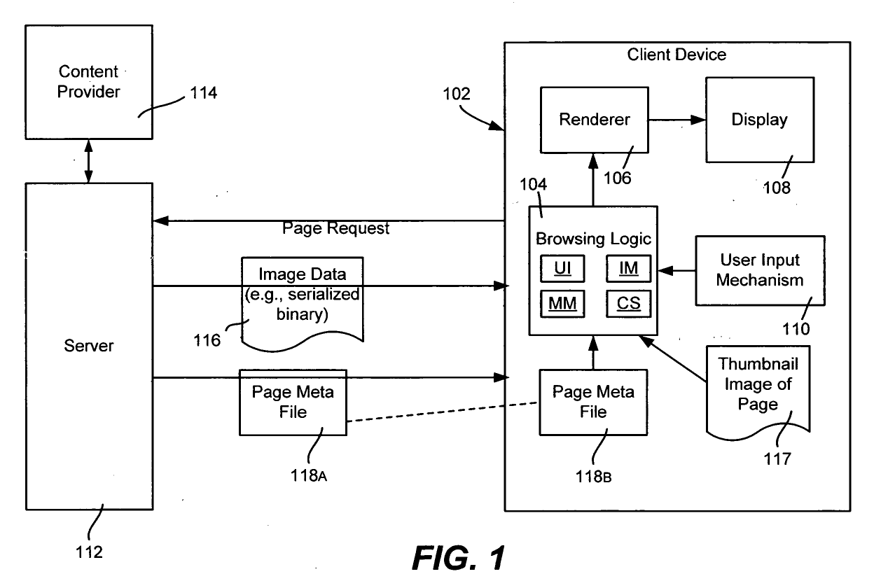

Turning to FIG. 1, there is shown a representation of a client (e.g., mobile) device 102 on which images of website data can be rendered. To this end, the client device 102 has browsing logic 104, a renderer 106 and a display screen 108. As is typical with browsers, a user input mechanism 110 such as a directional pad (D-Pad), joystick or the like enables the user to interact with the rendered content in some manner. In general, and as described below, in one example implementation the browser logic 104 is a component running on a client device 102 and is responsible for rendering the web page content and offering a user interface (UI) that provides ease of web page navigation.

However, unlike a conventional browsing solution, instead of providing the page itself to the client device, a server 112 converts a web page from a content provider 114 to an image, exemplified in FIG. 1 as image data 116 (e.g., in a serialized binary format) of the page. To this end, the server 112 internally renders an HTML-based webpage, and captures the rendered output to the image data 116. Note that compressed image data may be sent to the client device 102 for a more efficient user experience, e.g., a 300 Kb webpage may be sent as data that is on the order of about five or six times smaller than the page, whereby the client device quickly receives the image data 116.

Further, the HTML-based webpage is also analyzed at the server 112 and meta information of the HTML elements are extracted. The resulting image data 116 and meta file 118A are processed as described below and maintained at the client, as represented as a stored thumbnail image 117 and meta file 118B (or corresponding data) at the client device 102, respectively.

The web page, in the form of the thumbnail image 117, is rendered on the client device's display 108. As described below, with the help of information in the meta file 118B, any user interaction, such as clicking on hyperlinks, forms, and HTML controls is able to be converted to actions. In other words, the HTML functionality is preserved, even though the web page was converted to and is only displayed as an image, by capturing and translating user-triggered events on the device such as clicks into HTML actions.

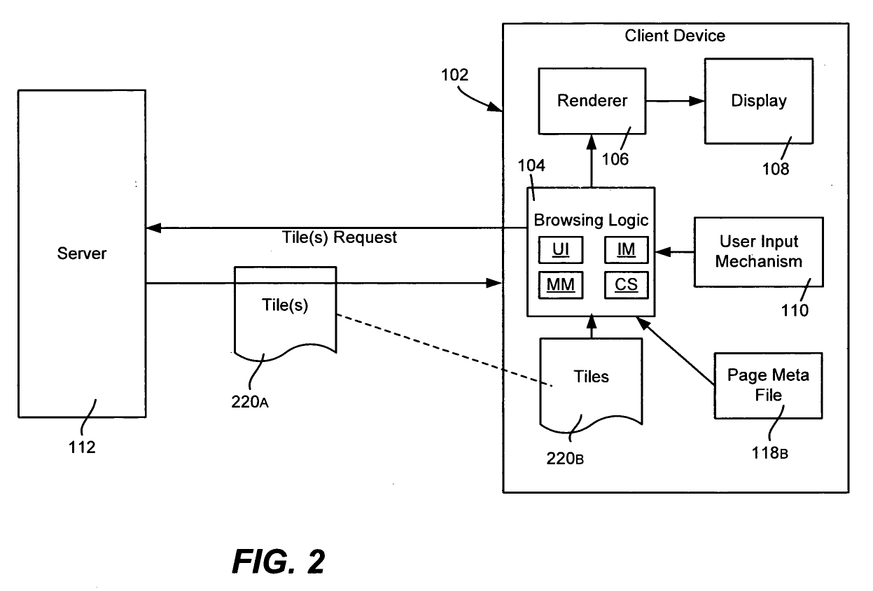

In another aspect, in addition to displaying the page as a thumbnail image 116B, the user is able to zoom into an area of the thumbnail image 116B and provide the user with an enlarged view of the selected area. This makes user interaction with the content far easier, and also eliminates or substantially reduces the need for scrolling. To this end, the server 112 breaks the webpage into tiles 120A, each comprising a larger and/or higher resolution image corresponding to part of the webpage, and sends the tiles 220A as requested by the client device 102, as generally represented in FIG. 2. Note that in an alternative described below, the client device can break a single page image into the tiles as needed.

The client builds an image to match the user chosen zoom area from a set of the stored tiles 220B. Note that the server 112 may also start sending the tiles 220A before they are actually requested by the client device 102, e.g., in a background operation, whereby the user experience may be further improved by having locally cached tile data waiting for possible use if and when the area corresponding to all or part of a tile is zoomed-in by the user.

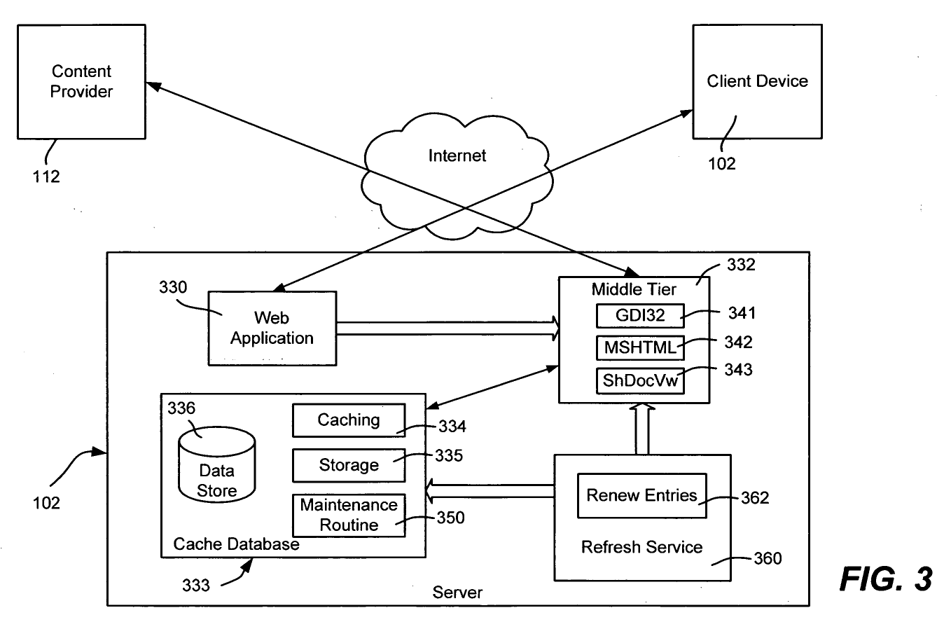

Turning to FIG. 3, the server 112 (e.g., an Internet Information Server) takes inputs from the client device 102, and sends back a web page as the image data 116 along with the meta file (properties) 118A describing the behavior of the web page to the client device 102. In one example implementation, the server 112 includes various components, comprising a web application 330 which acts as the entry point of the client requests. To this end, the web application 330 parses the client requests and sends them to a middle tier component 332.

The web application 330 (e.g., written in asp.net) is hosted on the server 112, and accepts HTTP calls from the client device 102. In one example implementation, the web application 330 accepts parameters including a target URL (the URL to which the client device is navigating), and a hash code of data last cached on the client, which the server may use to compare to the entries cached on the server and decide whether a new data is available. A refresh flag may be provided by the client to ask the server to disregard cached entries and regenerate a new image. After accepting the parameters, the web application 330 calls and passes the parameters to the middle tier component 332, receives a result, and sends the result back to the client device 102.

In the exemplified implementation of FIG. 3, the middle tier 332 hosts a form application which, given an target web page URL, looks for data in a cache database 333 (via a caching mechanism 334, storage 335 and data store 336) and returns the cached entry if available. Note that if the client has the data locally cached as indicated via the client-provided hash as matched at the server, the server may instead return an acknowledgement that the client data matches the server-cached data. Otherwise, the middle tier 332 navigates to the web page, and upon completion of a successful page load, essentially takes a “snapshot” of the rendered web page into the image data 116, compresses it and returns it as the image data 116 to the web application 330 along with the web page properties in the meta file 118A, for returning to the client device 102. The middle tier 332 also sends a copy of the data to the cache database 333 for future requests.

In one example implementation, the middle tier 332 is written in .net c# language, and also makes unmanaged calls via MSHTML, GDI32 and ShDocVw interfaces 341-343, respectively. As described above, the middle tier 332 accepts calls from the web application 330 and returns the web page as an image with the web page's property data; the middle tier 332 accepts the same input parameters as the web application 330.

The middle tier 332 may first query the database 333 to see corresponding cached entry is already available that matches the hash code of the cached entry with the input parameter. If hash codes match, the server sends the acknowledgement to the client indicating that the client's cached data is valid. If hash codes do not match, then the client's cache entry is expired, whereby client the middle tier 332 retrieves the server's cached entry for sending to the client. If the server does not have a cached entry that matches the hash (or the client did not provide a hash or directly requested a new page), or the server's entry has expired, then the middle tier 332 instantiates a form which hosts a .net web browser control and passes the target URL to the web browser control. After a page has been successfully rendered by the web browser control, the middle tier 332 parses the web page and collect the necessary web page properties such as the coordinates of the interactive elements, using MSTHML and ShDocVw interfaces 342 and 343, respectively, and takes a snapshot of the web page to convert it to an internal bitmap, e.g., by calling a COM interface IViewObject and stopping the form. For example, the internal web page bitmap image is compressed and stored as in PNG format using GDI+ and serialized to a binary array. The serialized binary array is then stored in the database 333 as a cached entry and sent back as the image data 116 to the web application 330.

In general, the database 333 stores the serialized web page images as well as the web page properties for each image. The cached entries are served when clients make a request to a web page that is already available in the database 333, to avoid redundant computation and bandwidth required to render the web page and capture it as an image. An example database 333 also features statistical data and a maintenance routine 350, e.g., a self diagnosis script, which removes an entry from the data store 336 if it has not been hit for some time, such as within twenty-four hours, and alert the operator when something is going wrong. This reduces the amount of maintenance work required to keep the service healthy.

Also represented in FIG. 3 is a refresh service 360 that constantly (or on some other schedule) looks for expired entries in the cache data store 336. A component 362 calls the middle tier 332 as needed to renew expired entries. In one example implementation, the refresh service 360 is an operating system service that continuously monitors the server side cache 333 and looks for expired entries, in which each entry properties associated with it, such as URL, expiration and hit count within some time frame, such as the last twenty-four hours. The refresh service uses the expiration to determine if an entry has expired and calls the middle tier to refresh it. This process speeds up the image rendering time by pre-generating the images before users actually needed them. This is especially useful for content on popular portal web sites or news web sites where many users regularly request the same pages.

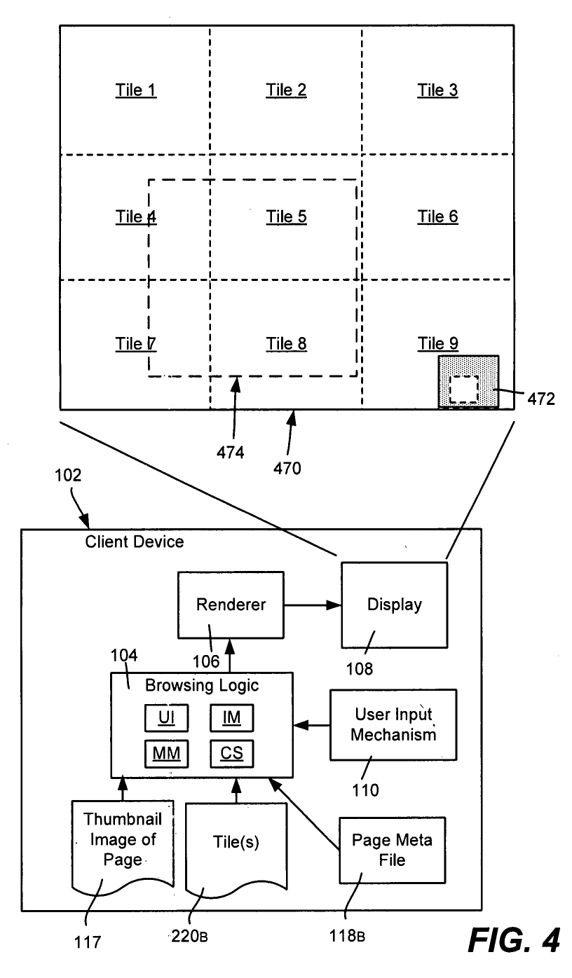

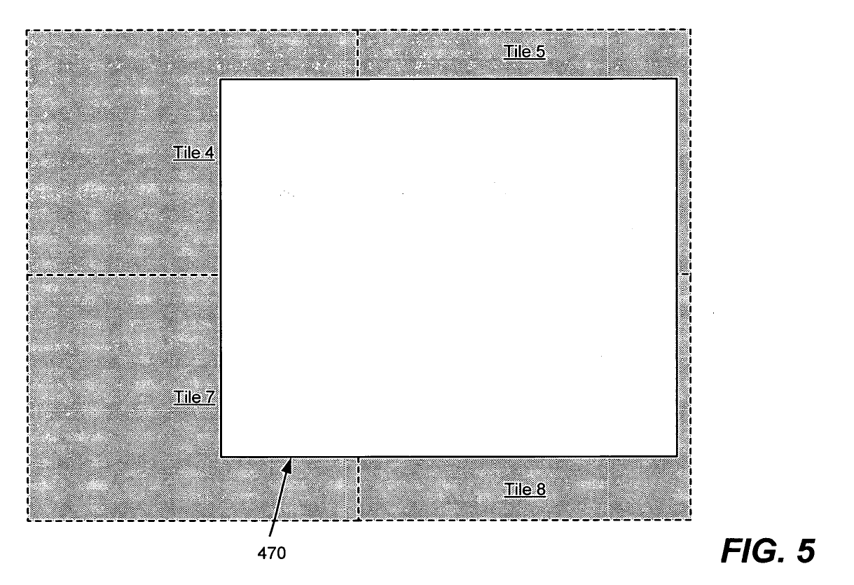

Turning to FIG. 4, in one example implementation, the browsing logic 104 includes the user interface (UI) that allows user to navigate to a web page, interact with the web page and handle various operating system events. Another example component is an internal image management class (IM), which produces the thumbnail image 117 from the server image data 116 image based on the device's form factor. Also, as described below with reference to FIG. 5, an image management class (IM) decides which part of a full page image (or tiled subset thereof) is displayed based on the current user interface's viewport 470. The metadata management (MM) class stores the properties of the interactive elements (e.g., as the page meta file 118B or in a suitable data structure containing corresponding data) and responds to received user input based on the element properties. Another client-side component is a local cache storage (CS) that reduces the need to download the image data and metafile over the network by serving it from the cache when present.

In general, the user interface (UI) provides features like desktop web browsers, such as Go to the homepage, Navigate to a URL, Go back to previous page, Go to the search page, Favorites, and so forth. As described above, when a user submits a request to browse a web page that is not in the local cache storage (CS), the user interface (UI) sends the request through the network to the server 112 and retrieves a binary serialized image data 116 along with the meta file 118A. The image data 116 and meta file data is then parsed by the internal image management (IM) class and rendered on the screen. After that, users can browse and interact with the web page. Note that on certain models of client devices, a screen orientation change is supported by the hardware, whereby the user interface is able to query for a new screen dimension and ask the Image management class to redraw the image that fits the new screen dimension.

In one alternative in which the server 112 sends the entire page image at once instead of a thumbnail and tiles, the image management (IM) class is responsible for decoding the serialized binary format image, producing the thumbnail 117, and drawing a portion of the image data onto the screen based on the current viewport 470. A map 472 or the like may be provided to inform the user as to the current position of the viewport relative to the entire page. Note that PNG decoding is already supported by such mobile devices, but the amount of memory required may be overwhelming and not always possible on the device. In such situations, in one alternative, the image management (IM) class may break down the full sized image into chunks (the client makes its own tiles) and decodes only the viewable area.

In one example implementation, the server provides a full image from which the thumbnail is produced at the client, because in this implementation, the server is client-independent, meaning it has no knowledge of the client's screen resolution and cannot produce the thumbnail tailored for the client screen resolution. In alternative implementations, the client can provide its resolution as a parameter whereby the server can customize the image data for the client.

Further, the client can request (and/or receive as a background process) tiles from the server, each tile comprising image data representing a portion of the full sized web page. This facilitates fast communication by sending smaller pieces, and also facilitates memory usage. In one alternative, a client may provide its resolution or like data whereby the server can provide tiles that match the client needs, or exceed the client needs whereby the client can down-convert the image tiles to a desired size and resolution. In FIG. 4, the thumbnail image of the full page is shown in the viewport 470, but (typically unknown to the user) corresponds to nine tiles, Tile 1 through Tile 9).

In one example, the image management (IM) class is called each time the user moves the viewport 470, such as by scrolling or dragging the image under the viewport 470. The image management (IM) class recalculates the part of the images that needed to be rendered and draws only the viewable area onto the screen. When a shaded box is required, the image management (IM) class calculates a shaded rectangle and darkens the pixels enclosed by the rectangle to produce a shaded effect. Similarly when a focus rectangle is required to highlight the current element having focus, the image management (IM) class draws a bounding rectangles surrounding the focus element.

In one alternative example represented in FIGS. 4 and 5, the user sizes and/or moves a zoom window 474 over the full thumbnail image 470. Then, when the user selects to zoom into the zoom window area 474, the area under the zoom window enlarges into the viewport 470 (FIG. 5). To this end, the relevant portions of each tile are assembled into a full screen image. For example, in FIG. 5 the viewport 470 contains partial image data from the tiles labeled Tile 4, Tile 5, Tile 7 and Tile 8; the rest of the tiles (as represented by the shaded regions) are not visible unless and until the user pans (or scrolls) them appropriately under the viewport 470.

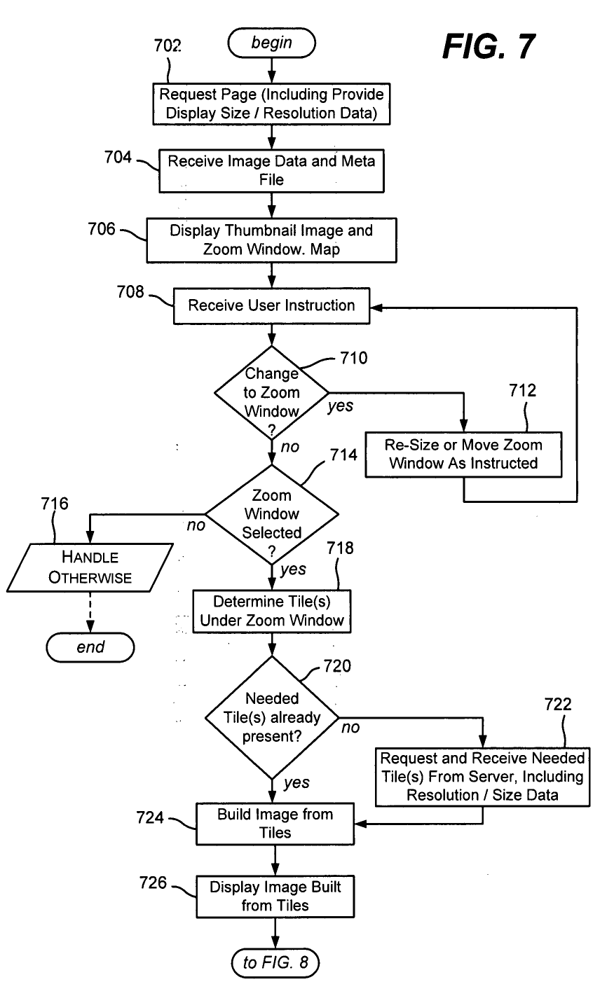

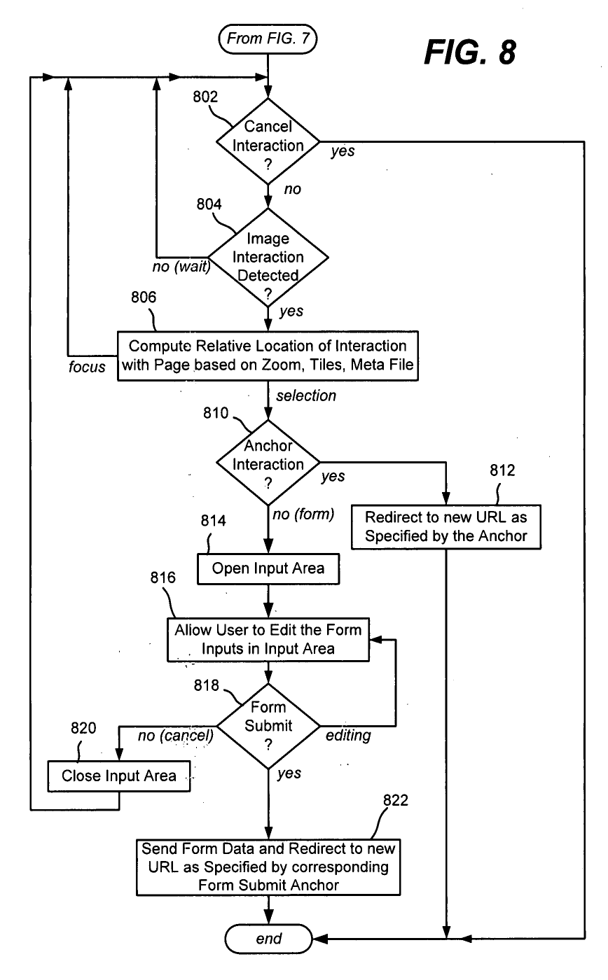

The metadata management (MM) class stores properties of HTML elements including their coordinates, sizes and corresponding actions. The coordinates and sizes are used to calculate elements currently in focus and the next element in focus based on user action. The actions associated with the elements decide what actions are to be taken when users interact with them, such as described below with reference to FIGS. 7 and 8.

The local cache storage (CS) is a file-based storage which, upon successful rendering of a web page, saves a copy of the binary data onto the device (e.g. its file system) along with a corresponding hash code. When a request to the same URL is made, the client device 102 sends the request with the additional hash code to the server 112. If the server matches the hash code to one at the server side cache, instead of sending the image data plus the metadata to the client, the server sends only a short acknowledgment back to the client. With the acknowledgement, the client retrieves data from its local cache to reduce the loading time and save connection bandwidth.

To summarize the tile and zoom alternative represented in FIGS. 4 and 5, the user interface starts with a thumbnail view of the web page the user is browsing, which is downsized (e.g., at the client and/or server) to match the client device's screen resolution and/or size. When the user selects a zoom window (e.g., the user presses a joystick), the zoom area 474 is highlighted in some way, such as a shaded box which when zoomed into will fill the viewport 470. The user may size, and/or move the zoom area.

As represented in FIG. 5, when the user elects to zoom in, the UI displays as the full sized image in the viewport 470 the same region that was enclosed with the shaded zoom window. The user may adjust the image under the viewport to navigate to the exact area the user wants to see in detail.

In this state, the user may click an interactive element, such as an anchor or input box, by an appropriate action, such as pressing on the joystick. When clicked, the browsing logic 104 looks for the nearest interactive element, e.g., in the center of the current viewport and highlights it. Users may also navigate to another interactive element to highlight.

If an already-highlighted element is further selected, an action occurs, which depends on the type of the element. For example, for an anchor, the browsing logic 104 redirects to a new URL as specified by the anchor. For form inputs, the browsing logic 104 may open a new window or other dialog, such as on top of the screen, to allow users to edit the value of the form inputs. For form submits, the browsing logic 104 acts as if the corresponding anchor was clicked, and also sends the form input values to the server 112 along with the request.

Users may also cancel actions, such as to go back to a previous step. For example, using a joystick, users may press and hold the joystick, causing a visual indication (e.g., a green small ball to be shown) that slowly changes its size and eventually changes its appearance (e.g., turns red). At this point, the user may release the joystick to go back to the previous step; releasing the joystick when the indication is in the first state (e.g., green) signifies moving forward to the next step.

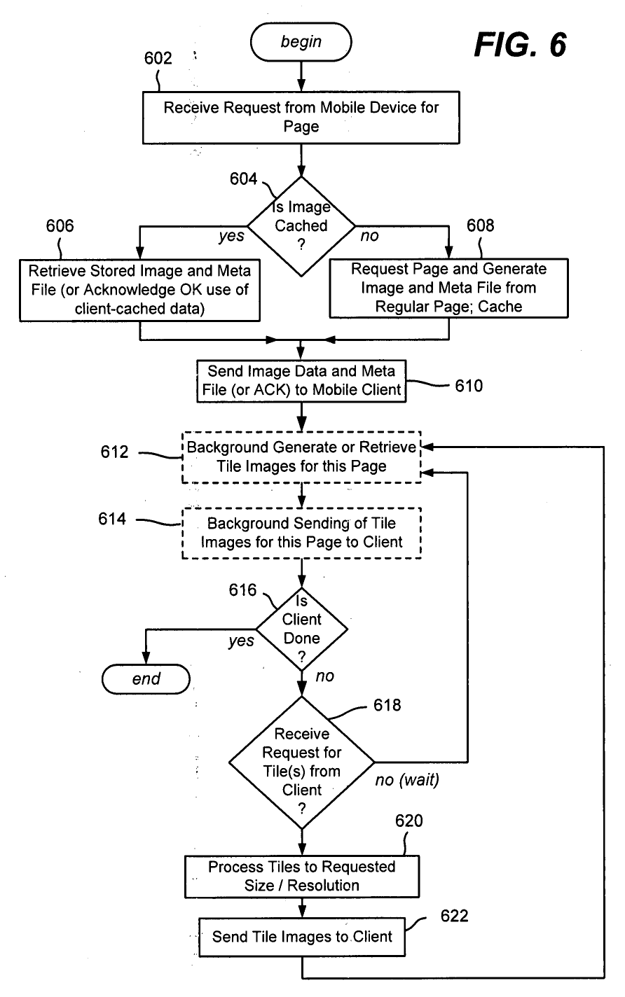

FIG. 6 is a flow diagram generally representing server to client communication when in an alternative tile-based implementation. Step 602 represents receiving the request from the client device 102 for a page. If the image data is cached as evaluated at step 604, the cached data is used via step 606; note that as described above, step 604 and 606 may represent checking the hash to determine that the client's cached data is valid, and if not, checking whether the server cache has the image and meta file. If so, this is sent to the client at step 610; (which as described above may simply be an acknowledgement that the client should use its own locally-cached data).

If not cached, step 608 is executed, which represents requesting the page from the content provider and generating the image data and meta file from that page. This image data and meta file also may be cached at the server at this time. Step 610 represents sending the image data and meta file to the client.

Steps 612 and 614, shown as dashed boxes to represent optional/alternative steps, represent retrieving (from the cache) and/or generating tiles as images corresponding to this page, and sending the tiles to the client. Step 616 represents the client indicating it wants no more data, such as by requesting a new page, closing the connection, timing out without any requests, and so forth. Otherwise, step 618 represents handling any on-demand requests for tiles, including processing them (step 620) at the server for size and/or resolution (if this feature is provided) and sending them to the client (step 622).

FIG. 7 represents client actions, starting at step 702 which requests a page, optionally providing size and/or resolution data when such a feature is provided by the server. Step 704 represents receiving an image in place of the page, with step 706 displaying the thumbnail representation and presenting a zoom area (when requested by the user or by default, along with the navigation map).

Step 708 represents receiving any further user instruction, such as to change the zoom window size and/or location (steps 712 and 712) or select the zoom window. If selected as evaluated via step 714, the corresponding tiles under the zoom window are determined at step 718. Note that step 716 represents handling another user instruction, such as Go home, back, favorites, end, and so forth that otherwise halt further interaction with respect to the current page.

Step 720 represents determining whether the needed tiles are already present at the client. All tiles may be automaticaily present in the alternative in which the entire compressed image was transmitted by the server and it is up to the client to decompress tiles as needed. In the alternative in which the server is providing tiles for this image to the client on demand or in the background, any needed tiles are requested via step 722, which may include-providing the server with resolution and/or size data for the needed tiles.

Step 724 represents building the full viewport image based on the tiles, which is then displayed via step 726. At this time, the user is ready to interact with the zoomed-in image, as generally represented in FIG. 8.

Step 802 of FIG. 8 handles the user canceling the interaction, which may be via a back button, a zoom-out to full thumbnail image button, or any other action by the user indicating interaction is not desired, such as by requesting a new page via a home or favorites mechanism, closing the browser window/connection, timing out without making any requests, and so forth.

Step 804 represents detecting interaction with the image in some way. When this occurs, step 806 computes what the user intended based upon the meta file data, which portion of the page image (tiles) is currently being shown, and the current zoom factor.

Step 810 represents evaluating selection of an already focused element. (Note that focus setting or focus change is represented in FIG. 8 by the branch back to step 802 rather than a separate decision diamond, for purposes of simplicity.) If the user interaction was deemed to be selection of an anchor, step 810 branches to step 812 which redirects to the URL specified by the anchor.

If not an anchor, the other option represented in FIG. 8 is user selection of a form. Note that other actions may be taken, such as to activate a control, but anchor selection and form selection are used as the examples in FIG. 8 for purposes of simplicity. If a form input is the selection, step 814 opens a form input area (e.g., a window atop the device screen), while step 816 represents the editing process, which continues via in this example until canceled directly or indirectly (which closes the input area at step 820), or the form is submitted at step 818. If submitted, the form data is sent to the server along with a request to redirect the client device to a new URL.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer-readable medium having computer-executable instructions, which when executed perform steps, comprising:
receiving a request for a page;
retrieving the page;
converting the page to image data and properties of elements of the page represented in the image data; and
sending the image data and properties in response to the request.

2. The computer-readable medium of claim 1 wherein retrieving the page comprises obtaining the page from a server cache, or requesting a page from a content provider.

3. The computer-readable medium of claim 1 wherein converting the page to image data comprises rendering the page with a browser, and generating the image data from the rendered page as compressed binary serialized data.

4. The computer-readable medium of claim 1 having further computer-executable instructions, comprising receiving a subsequent request for the page and a value that identifies an client instance of cached data corresponding to the page, and returning an acknowledgement in response to the subsequent request indicating that the client instance or cached data is valid.

5. The computer-readable medium of claim 1 wherein sending the image data and properties in response to the request comprises sending a full set of data from which a thumbnail image and one or more tiles may be generated by a client recipient.

6. The computer-readable medium of claim 1 wherein sending the image data and properties in response to the request comprises sending a first set of data corresponding to a thumbnail image of the page to a client recipient, and sending at a second set of data comprising at least one tile to the client recipient.

7. The computer-readable medium of claim 6 wherein at least part of the second set of data is sent in response to a request from a client, or in a background operation, or in a combination of being sent in response to a request from a client and in a background operation.

8. A computer-readable medium having computer-executable instructions, which when executed perform steps, comprising:
requesting a page of content from a server;
receiving image data corresponding to a server-rendered image of the page, and property data associated with elements of the page represented in the image data;
displaying a representation of at least part of the page based on the image data; and
using the property data to convert user input actions relative to the displayed representation into interactive browsing actions relative to elements of the page that are visible in the displayed representation.

9. The computer-readable medium of claim 8 having further computer-executable instructions, comprising caching the image data and property data in a local cache, providing a hash value corresponding to the page in a subsequent request for that page to the server, receiving an indication from the server that the image data and property data in a local cache is still valid, and using the cached image data and property data to display a subsequent representation of at least part of the page.

10. The computer-readable medium of claim 8 having further computer-executable instructions, comprising providing a zoom area relative to the displayed representation, and in response to detection of a zoom-in selection, providing a zoomed-in representation of a part of the displayed representation that was within the zoom area when the zoom-in selection was detected.

11. The computer-readable medium of claim 10 wherein providing the zoomed-in representation comprises constructing the zoomed-in representation from a tile set comprising at least one tile.

12. The computer-readable medium of claim 11 having further computer-executable instructions, comprising generating at least part of the tile set from the image data, or retrieving at least part of the tile set from the server.

13. The computer-readable medium of claim 10 wherein providing the zoom area comprises providing a visible indication of the zoom area, and allowing the visible indication to be resized or moved, or both resized and moved.

14. The computer-readable medium of claim 10 having further computer-executable instructions, comprising providing a map indicative of the zoom area relative to the displayed representation of the page image.

15. The computer-readable medium of claim 10 wherein using the property data comprises, determining with which element a user is attempting to interact based on the zoomed-in representation, including determining which portion of the displayed representation of the page is currently zoomed-in, and determining the element in that portion based on a zoom factor.

16. The computer-readable medium of claim 15 wherein the element corresponds to a form, and having further computer-executable instructions comprising providing an input area for receiving form data.

17. The computer-readable medium of claim 15 wherein the element corresponds to an anchor, and having further computer-executable instructions comprising redirecting to another page corresponding to the anchor.

18. In a networking environment, a system comprising:
a server;
a client coupled for communication with the server to request a web page from the server;
the server retrieving the web page, converting the page to image data and properties of elements of the page that are represented in the image data, and sending the image data and properties to the client in response to the request; and
the client displaying a representation of at least part of the page based on the image data, and using the properties to emulate user interaction corresponding to the displayed representation as user interaction with the elements of the web page.

19. The system of claim 18 wherein the server converts the page to image data including a thumbnail image and a set of at least two tiles, each tile corresponding to a set of enlarged image data relative to the thumbnail image.

20. The system of claim 18 wherein the client provides a zoom area relative to the displayed representation, and in response to detection of a zoom-in selection, provides a zoomed-in representation of a part of the displayed representation that was within the zoom area when the zoom-in selection was detected.
